(19) United States
(12) Patent Application Publication
(10) Pub. No.: US 2014/0240284 A1
(43) Pub. Date: Aug. 28, 2014

(54) SYSTEM FOR USING SYNCHRONIZED TIMED ORTHOGONAL MEASUREMENT PATTERNS TO ENABLE HIGH UPDATE REPORT RATES ON A LARGE CAPACITIVE TOUCH SCREEN

(71) Applicant: CIRQUE CORPORATION, Salt Lake City, UT (US)

(72) Inventor: Keith L. Paulsen, Centerville, UT (US)

(73) Assignee: CIRQUE CORPORATION, Salt Lake City, UT (US)

(21) Appl. No.: 14/191,788

(22) Filed: Feb. 27, 2014

Related U.S. Application Data
(60) Provisional application No. 61/770,033, filed on Feb. 27, 2013.

(51) Int. Cl. G06F 3/041; G06F 3/044

(52) U.S. Cl. CPC G06F 3/0416; G06F 3/044
USPC 345/174

(57) ABSTRACT

A system and method for increasing a report rate on a capacitive touch sensor to thereby provide a real-time display of the position of all the objects on a touch screen that is using synchronized timed orthogonal measurement stimulus patterns to determine the position of objects on the touch sensor, by updating an image of the reported positions of objects on the touch sensor each time that a measurement is taken on each of the sensor electrodes instead of waiting for a complete scan of all the sensor electrodes in a sensor electrode array.

### BACKGROUND OF THE INVENTION

1. Field of the Invention

This invention relates generally to capacitive touch sensors. More specifically, the present invention is directed to increasing a report rate in order to provide improved detection rates when using a capacitive touch sensor that uses synchronized timed orthogonal measurement stimulus patterns to determine the position of objects on the touch sensor, including when the touch sensor is combined with a large display to form a large touch screen.

2. Description of Related Art

When discussing touch sensors, it is noted that there are several different designs for capacitance sensitive sensors. One of the existing touchpad designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24.

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

The underlying technology for the CIRQUE® Corporation touchpad is based on capacitive sensors. However, other touchpad technologies can also be used for the present invention. These other proximity-sensitive and touch-sensitive touchpad technologies include electromagnetic, inductive, pressure sensing, electrostatic, ultrasonic, optical, resistive membrane, semi-conductive membrane or other finger or stylus-responsive technology.

It has been noted that when using large touch screens such as a large tablet computer, touch screen computer or other similar touch screen device, the touch screen may not be as quick to report the position of detectable objects on the touch screen. For example, a touch screen may not keep up with the movements of a finger or fingers on the touch screen by not accurately reflecting the position of the fingers as they move. It would therefore be an advantage over the state of the art in touch sensors used in larger touch screens or touchpads to be able to more rapidly update the position of all the objects on the touch sensor by increasing a report rate.

### BRIEF SUMMARY OF THE INVENTION

In a first embodiment, the present invention is a system and method for increasing a report rate on a capacitive touch sensor to thereby provide a real-time display of the position of all the objects on a touch screen that is using synchronized timed orthogonal measurement stimulus patterns to determine the position of objects on the touch sensor, by updating an image of the reported positions of objects on the touch sensor each time that a measurement is taken on each of the sensor electrodes instead of waiting for a complete scan of all the sensor electrodes in a sensor electrode array.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

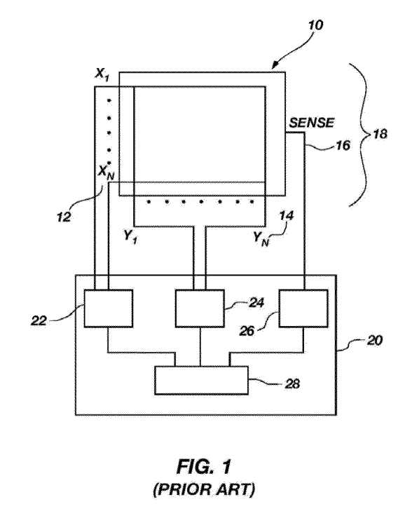

FIG. 2 is a top view of a touch sensor comprised of an array of X and Y electrodes disposed on two layers of a touch sensor substrate.

FIG. 3 is an illustration of the data arrays that are used to store measurement results, stimulus patterns and a results array from which an image of the touch sensor may be created.

FIG. 4 is a flowchart of the method of a first embodiment of the invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

It should be understood that use of the term “touch sensor” throughout this document may include any capacitive touch sensor device, including touchpads, touch screens and touch panels, and includes proximity and touch sensing capabilities.

The first embodiment of the invention is an improvement over the state of the art because the system and method enables a higher report rate of the position of objects on a touch sensor. A report rate may be defined as a rate at which a touch sensor may provide position information for detectable objects. The report rate may be based on the number of measurements that may be made in order to produce an image of all the objects that are detectable by the touch sensor.

Recent advances in touch screen technology, including larger screens for tracking multiple objects, have created the need for faster report rates to thereby provide a substantially similar user experience as with smaller touch screens. Current state of the art systems include making a complete scan of the entire active area, or all of the sense electrodes in a sense electrode array, and then generating or calculating an image from the measurement data. The location of each object in the active area is then extracted from the image data by processing the image data. Thus, an image using state of the art scanning techniques may only be created after a complete scan is performed. A complete scan may be defined as all the measurements being taken from the sense electrodes by applying all of the necessary stimulus patterns for the electrodes that are functioning as drive electrodes. Typically, a stimulus pattern is applied to each of the drive electrodes while a measurement is taken from all of the sense electrodes for each stimulus pattern that is applied.

It should be understood that the stimulus patterns being applied are synchronized timed orthogonal measurement stimulus patterns as taught in the previously filed application having Ser. No. 12/855,545 and filed on Aug. 12, 2010.

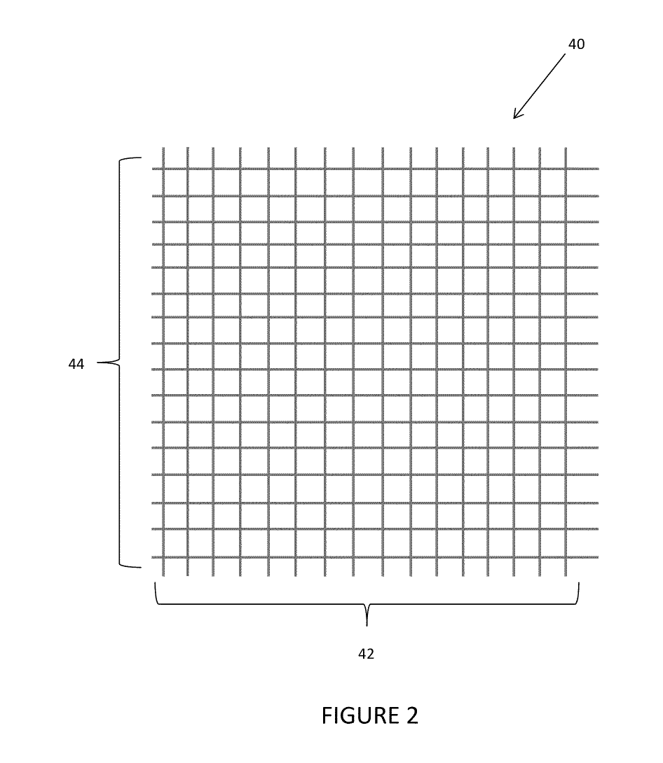

Consider FIG. 2 which illustrates a 16×16 array of electrodes that form an X 42 and a Y 44 array of electrodes used in a touch sensor 40. The state of the art may require a complete scan or 15 measurements in order to obtain an image of all of the objects that may be present on the touch sensor 40. So in this example, the report rate is a function of the complete scan that may require 15 measurements that may need to be made before an image may be generated.

It should be understood that the example of a 16×16 touch sensor array 40 is arbitrary and is for illustration purposes only. The number of X and Y electrodes 42, 44 may be changed to create a rectangular touch sensor 40 having any desired dimensions, and is not limited to a square layout as shown. The X and the Y electrodes 42, 44 may also be used interchangeably with m and n electrodes to be described.

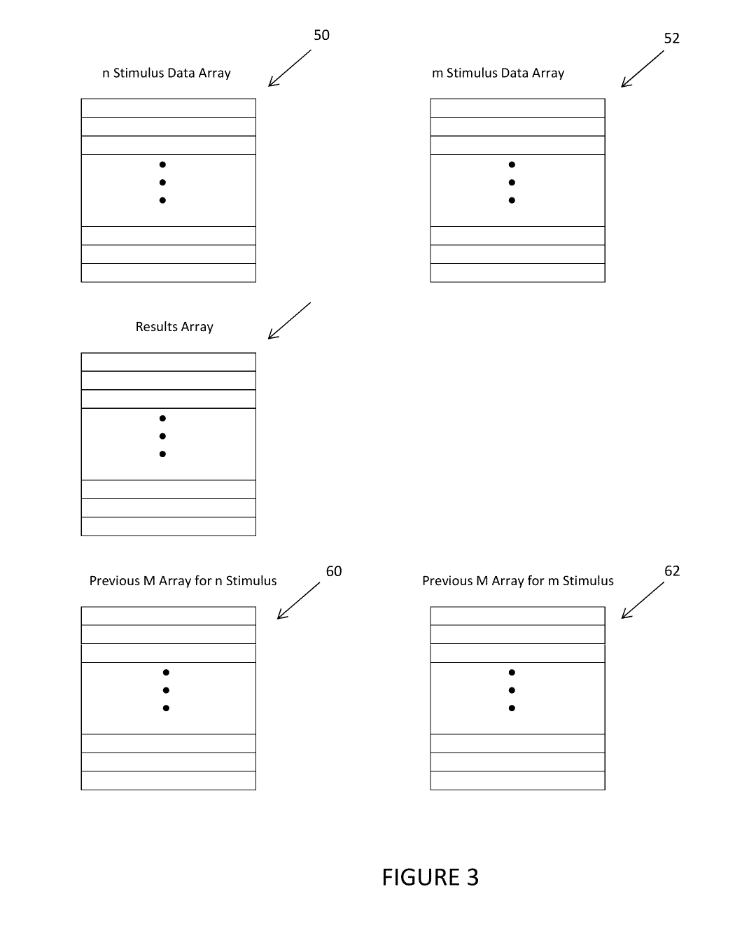

FIG. 3 is an illustration of data arrays that may be used by the first embodiment of the present invention. A stimulus data array stores a plurality of stimulus patterns. The stimulus patterns are applied to the electrodes that may be selected to function as the drive electrodes. Generally, when the X electrodes function as the drive electrodes, the Y electrodes will function as the sense electrodes, and vice versa. The designation of being drive electrodes or sense electrodes is therefore interchangeable. For example, the X electrodes may function as the drive electrodes while the Y electrodes may function as the sense electrodes, and then the roles are reversed until a complete scan has been taken.

For an array of n×m electrodes, there is an array of n stimulus patterns when the n electrodes function as drive electrodes. Likewise, there is an array of m stimulus patterns when the m electrodes function as drive electrodes. Because the stimulus patterns may need to be different for the n electrodes and the m electrodes, there may be two different stimulus arrays for storing the stimulus patterns for the n and m electrodes. Thus there may be an n Stimulus Data Array 50 and an m Stimulus Data Array 52. The stimulus patterns may need to be different, for example, when there are more electrodes in one dimension than in the other dimension.

For the purposes of this example, FIG. 3 shows two different stimulus arrays, the n Stimulus Data Array 50 has n different stimulus patterns for the n electrodes, and the m Stimulus Data Array 52 has m different patterns for the m electrodes. However, it should be understood that when the number of electrodes are equal, or n=m, it may be possible to use a single Stimulus Data Array for storing the stimulus patterns to be applied to both sets of electrodes.

The first step of the first embodiment may be to generate the first image of objects on the touch sensor 40. In this example, n+m measurements may be required to generate the entire image when the drive electrodes are being stimulated using the n and m stimulus patterns.

The second step is to select an index value using a random, pseudo random or permutation method. The index value is a value that is used to access the stimulus pattern to be used, the value to be updated in a Results Array 54, and the value to use from a Previous Measurement Array for m Stimulus 60 and a Previous Measurement Array for n Stimulus 62, as will be shown.

The third step may result in the desired higher report rate. Instead of having to take a complete image of the objects on the touch sensor 40 by stimulating each of the drive electrodes with its own stimulus pattern as in the prior art, a new image is created after stimulating a single drive electrode and taking just a single measurement.

FIG. 3 shows the Results Array 54, the Previous Measurement Array for n Stimulus 60 and the Previous Measurement Array for m Stimulus 62. In the first step, the complete scan created the Results Array 54 having an image of all of the objects or in proximity of the touch sensor 40. In the prior art, in order to update this image, another complete scan is performed. However, in the first embodiment, the next step is to subtract the measurement results that correspond to the selected index value i from the Results Array 54. More specifically, the vector dot product of a previous measurement is subtracted from the Results Array 54.

Turning again to an example using the n electrodes as the drive electrodes first, consider the index value i to be three. The measurement that came from the third stimulus pattern, which may be denoted as the third measurement from the n array, or M(3)n, and which is stored in the Previous Measurement Array for n Stimulus 60, is subtracted from the Results Array 54, and then the third measurement M(3)n is removed from the Previous Measurement Array for n Stimulus.

The next step is to stimulate the drive electrodes with a new stimulus pattern. Therefore, the third stimulus pattern stored in the n Stimulus Data Array 50 is used to generate a new measurement M(3)n. By using the third stimulus pattern stored in the n Stimulus Data Array 50, the new measurement M(3)n is taken and then stored in the Previous Measurement Array for n Stimulus 60 in the third position.

Now that we have removed or subtracted the measurement results from the Results Array 54 and then taken a new measurement, the next step is to add the results of the new measurement M(3)n to the Results Array. This step does not mean that the new measurement M(3)n is literally added to the Results Array 54. In more precise terms, the dot product is taken of the new measurement M(3)n and the existing image stored in the Results Array 54, as will be explained.

Once the Results Array 54 has been completely filled for the first time to create the first image, a new image is generated after each new measurement, leaving all the previous measurements untouched. In other words, once the new stimulus pattern to be applied is identified, the previous measurement results are subtracted from the Results Array 54, a new measurement is taken using the new stimulus pattern, and then the new measurement results are both added to the Results Array 54 and stored in the array 60 or 62 that is storing the new measurements. The arrays storing the new measurements are the Previous Measurement Array for n Stimulus 60 and the Previous Measurement Array for m Stimulus 62.

Once the Results Array 54 has been modified by adding the new measurement M(3)n, a new image on the touch sensor 40 is generated and then the objects on the touch sensor are again identified. Thus, the Results Array 54 may now be processed to create a new image of all the objects on the touch sensor 40 using methods known to those skilled in the art.

It should be understood that the movement of an object or objects on the touch sensor 40 between each single measurement will likely be very small because the complete process for changing the Results Array 54 after only a single measurement is updated is going to be relatively rapid. In other words it may be possible to take a new measurement and generate a new image anywhere from 10 to 2000 times per second.

The process is now repeated for each of the other index values until all of the stimulus patterns in the n Stimulus Data Array have been used without repeating any of the stimulus patterns. In other words, no index value is repeated until all the index values have been used. The process may also be performed using the m Stimulus Data Array 52 until all of the stimulus patterns are applied. Applying all of the n stimulus patterns and all of the m stimulus patterns repeats as long as one or more objects are detected on the touch sensor 40.

The report rate is therefore increased because a new image of all the objects on the touch sensor 40 may be created after each measurement is made instead of having to wait until all the index values have been used. The new image may be created as fast as after a stimulus pattern is applied and a new measurement is taken.

Some aspects of the first embodiment are directed to the selection of the index values. First, the index values are generally not going to be selected in numerical order. The selection of the index values may be random, pseudo random or permuted.

There may be advantages to the selection of some sort of randomly selected index values in this manner. A first advantage may be a reduction in noise susceptibility. For example, if the index values are selected in numerical order, noise on the sense electrodes that follows a similar predictable pattern could reduce accuracy of the measurements.

Another advantage to this method of index value selection is increased security of the touch sensor 40. If there is an intrusion by a probe or if in some other way the data generated by the touch sensor 40 is being intercepted and monitored, a non-predictable and non-sequential selection of index values may increase security of the touch sensor and the data that is being collected.

Another advantage is that the resulting image is the same as if an image generated from the Results Array 54 was initialized to zeroes and all synchronized timed orthogonal measurement stimulus patterns and measurements were processed again. This method provides a complete image with every measurement instead of only after each complete scan of the touch sensor 40. For example, the image report rate for a touch sensor 40 having 16×16 electrode array is 15 times higher than the report rate using the method of the prior art.

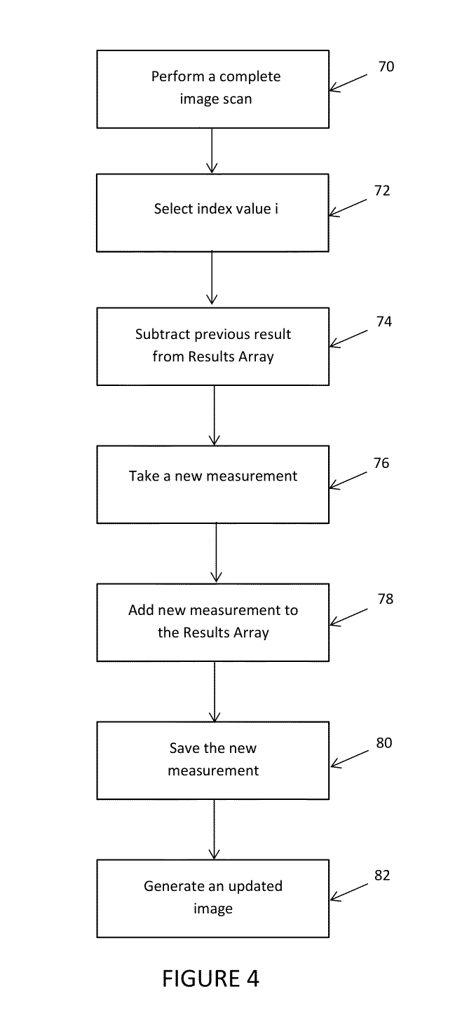

FIG. 4 is provided to show the following method and equations that are provided as a representation of the concepts above while using the n electrodes as the drive electrodes. The same process may be repeated for the m electrodes.

Step 1 in item 70 is to perform a complete image scan to generate a complete Results Array 54 using all of the n and m stimulus patterns.

Step 2 in item 72 is to select an index value i.

Step 3 in item 74 is to subtract out a previous result from the Results Array 54 by subtracting the vector dot product of a previous measurement from the Results Array using the new index value I, where P(i) are the previous results stored in the Results Array.

Image−=Previous M(i)n·dot·P(i)

Step 4 in item 76 is to take a new measurement M(i)n using the new index value i.

Step 5 in item 78 is to add the new measurement vector dot product to the image stored in the Results Array 54 using the new index value i.

Image+=M(i)n·dot·P(i)

Step 6 in item 80 is to save the new measurement in the previous measurements array where the previous measurement was stored (Previous Measurement Array for n Stimulus 60 and Previous Measurement Array for m Stimulus 62).

Previous M(i)n=M(i)n

Step 7 in item 82 is to generate an updated image using the updated Results Array 54.

The index value i is updated so that all the possible index values are used before an index value is repeated, and then steps 3 through 8 are repeated. This process may be performed for the n electrodes when they are the drive electrodes, then performed for the m electrodes when the function of the electrodes is switched and the m electrodes function as the drive electrodes. This process may be repeated back and forth between the n and m electrodes as long as an object is detected on the touch sensor 40.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for increasing a report rate of a position of at least one object on a touch sensor, said method comprising:
providing a touch sensor including a substantially orthogonal array of X and Y electrodes disposed on two layers of a touch sensor substrate, the X and Y electrodes being capable of functioning as drive and sense electrodes;
creating an image of the at least one object on the touch sensor by applying synchronized timed orthogonal measurement stimulus patterns to the X and the Y electrodes; and
providing an increased report rate by updating the image of the touch sensor after applying a single stimulus pattern to the touch sensor.

2. The method as defined in claim 1 wherein the method further comprises providing an array of synchronized timed orthogonal measurement stimulus patterns for the X electrodes and for the Y electrodes, and referred to as an n Stimulus Data Array and an m Stimulus Data Array, respectively.

3. The method as defined in claim 2 wherein the method further comprises providing a Results Array for storing an image of the at least one object on the touch sensor.

4. The method as defined in claim 3 wherein the method further comprises providing a Previous Measurement Array for n Stimulus for storing previous measurements when applying stimulus from the n Stimulus Data Array, and providing a Previous Measurement Array for m Stimulus for storing previous measurements when applying stimulus from the m Stimulus Data Array.

5. The method as defined in claim 4 wherein the method further comprises selecting an index value i that is used to apply the synchronized timed orthogonal measurement stimulus pattern to the touch sensor.

6. The method as defined in claim 5 wherein the method further comprises selecting the index value i using a random, pseudo random or permutation method.

7. The method as defined in claim 6 wherein the method further comprises using a random, pseudo random or permutation method to select the index value i to thereby reduce susceptibility of the touch sensor to noise.

8. The method as defined in claim 7 wherein the method further comprises using a random, pseudo random or permutation method to select the index value i to thereby increase security of the touch sensor by using a non-predictable and non-sequential selection of index values.

9. The method as defined in claim 6 wherein the method further comprises subtracting the measurement results M(i)n that correspond to that index value i from the Results Array by subtracting the vector dot product of a previous measurement stored in the Previous Measurement Array for n Stimulus.

10. The method as defined in claim 9 wherein the method further comprises taking a new measurement M(i)n using a stimulus pattern that corresponds to the index value i and which is stored in the n Stimulus Data Array.

11. The method as defined in claim 10 wherein the method further comprises adding the measurement M(i)n that corresponds to that index value i to the Results Array by adding the vector dot product of the new measurement M(i)n to the Results Array.

12. The method as defined in claim 11 wherein the method further comprises storing the new measurement M(i)n in the Previous Measurement Array for n Stimulus.

13. The method as defined in claim 12 wherein the method further comprises updating the image of the at least one object on the touch sensor.

14. The method as defined in claim 13 wherein the method further comprises using a particular index value only once until all possible index values have been used one time for applying the synchronized timed orthogonal measurement stimulus patterns to the touch sensor.

15. The method as defined in claim 14 wherein the method further comprises performing the method for the touch sensor using the X and the Y electrodes by using the Previous Measurement Array for n Stimulus and the n Stimulus Data Array and the Previous Measurement Array for m Stimulus and the m Stimulus Data Array.

16. The method as defined in claim 15 wherein the method further comprises repeating the process of applying stimulus to the X and the Y electrodes as long as the at least one object is detected by the touch sensor.

17. A method for increasing a report rate of a position of at least one object on a touch sensor, said method comprising:
providing a touch sensor including a substantially orthogonal array of X and Y electrodes disposed on two layers of a touch sensor substrate, the X and Y electrodes being capable of functioning as drive and sense electrodes;
creating an image of the at least one object on the touch sensor by applying synchronized timed orthogonal measurement stimulus patterns to the X and the Y electrodes; and
providing an increased report rate by updating the image of the touch sensor by:
a. selecting an index value i and then subtracting a previous measurement result corresponding to the index value i from a results array;
b. taking a new measurement using a stimulus pattern that corresponds to the index value i;
c. adding the new measurement to the results array;
d. saving the new measurement value in a previous measurement results array; and
e. updating the image of the at least one object on the touch sensor.

18. The method as defined in claim 17 wherein the method further comprises selecting an index value i that is used to apply the synchronized timed orthogonal measurement stimulus pattern to the touch sensor.

19. The method as defined in claim 18 wherein the method further comprises selecting the index value i using a random, pseudo random or permutation method.

20. The method as defined in claim 19 wherein the method further comprises using a random, pseudo random or permutation method to select the index value i to thereby reduce susceptibility of the touch sensor to noise.

21. The method as defined in claim 20 wherein the method further comprises using a random, pseudo random or permutation method to select the index value i to thereby increase security of the touch sensor by using a non-predictable and non-sequential selection of index values.
